(19) United States
(12) Patent Application Publication
(10) Pub. No.: US 2016/0173327 A1
(43) Pub. Date: Jun. 16, 2016

(54) MISSION MODULE FOR MOBILE AD HOC NETWORKING

(71) Applicant: THALES DEFENSE & SECURITY, INC., Clarksburg, MD (US)

(72) Inventors: Alan BOONIE, Waynesboro, PA (US); Aditya Agarwal, Gaithersburg, MD (US); John Kabelac, Potomac, MD (US); Paul Brown, Westminster, MD (US)

(21) Appl. No.: 14/967,141

(22) Filed: Dec. 11, 2015

Related U.S. Application Data
(60) Provisional application No. 62/091,388, filed on Dec. 12, 2014.

(51) Int. Cl. H04L 12/24; H04W 72/04; H04W 12/06

(52) U.S. Cl. CPC H04L 41/0803; H04W 12/06; H04W 72/0453; H04W 84/18

(57) ABSTRACT

A device for mobile ad hoc networking is provided. The device may include a hand-held radio configured to communicate using a first radio technology with a first communications network. The device may include a mission module configured to communicate using a second radio technology with a second communications network. For example, the mission module may be removably attached to the hand-held radio. In a further example, the hand-held radio may be further configured to communicate with the second communications network via the mission module.

### CROSS-REFERENCE TO RELATED APPLICATION(S)

This application claims the benefit of U.S. Provisional Application Ser. No. 62/091,388, entitled “MISSION MODULE FOR MOBILE AD HOC NETWORKING” and filed on Dec. 12, 2014, which is expressly incorporated by reference herein in its entirety.

### TECHNICAL FIELD

The disclosure relates generally to the field of radio frequency communication systems, and more specifically to devices, systems, and methods for providing mobile ad hoc networking capability to a radio system.

### BACKGROUND

In the military, many communications officers may be required to communicate on various frequency bands and with different networks using different radio technologies. Unfortunately, this requires officers to carry multiple communication devices, one for each particular frequency band and radio technology, and their respective operating manuals, among other items. This situation presents a large physical burden on officers, while hampering their communication effectiveness during missions.

Therefore, there exists an unmet need in the art for devices, systems, and methods for providing additional radio technologies, such as mobile ad hoc networking, to a radio system.

### SUMMARY

In light of the above described problems and unmet needs, aspects of the design, development and testing of a mission module for mobile ad hoc networking is presented herein. These aspects may be used, e.g., for combining various communication devices, each using a particular frequency band and/or radio technology. Thus, the method, system, and computer-readable medium system of the present disclosure are able to reduce the physical burden on officers while improving communication effectiveness during missions, among other things.

In an aspect of the disclosure, a method, a computer-readable medium, a device, and a system for mobile ad hoc networking are provided. The method, medium, and system may receive a first signal at a hand-held radio from a first communications network using a first radio technology. The method, medium, and system may receive a second signal at a mission module that may be removably attached to the hand-held radio, wherein the second signal may be received at the mission module from a second communications network using a second radio technology. The method, medium, and system may communicate with the first communications network via the hand-held radio while contemporaneously communicating with the second communications network via the mission module.

In an aspect of the disclosure a device for mobile ad hoc networking is provided. The device may include a hand-held radio configured to communicate using a first radio technology with a first communications network. The device may include a mission module configured to communicate using a second radio technology with a second communications network. For example, the mission module may be removably attached to the hand-held radio. In a further example, the hand-held radio may be further configured to communicate with the second communications network via the mission module.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

The accompanying drawings, which are incorporated into and constitute a part of this specification, illustrate one or more example aspects of the disclosure and, together with the detailed description, serve to explain their principles and implementations.

FIG. 1 is a diagram illustrating an example aspect of a system for providing mobile ad hoc networking capability to a radio system according to one aspect of the disclosure.

FIG. 2A is a diagram illustrating a side view of an example aspect of a mission module system for providing mobile ad hoc networking capability to a radio system according to one aspect of the disclosure.

FIG. 2B is a diagram illustrating an exploded view of an example aspect of the mission module system for providing mobile ad hoc networking capability to a radio system according to one aspect of the disclosure.

FIG. 3 is a flow diagram illustrating an example method for providing mobile ad hoc networking capability to a radio system according to one aspect of the disclosure.

FIG. 4 is a block diagram of a mission module that provides mobile ad hoc networking capability to a radio system according to one aspect of the disclosure.

FIG. 5 is a diagram illustrating an example aspect of a general-purpose computer system on which may be implemented one or more aspects of the systems and methods for providing mobile ad hoc networking capability to a radio system according to one aspect of the disclosure.

### DETAILED DESCRIPTION

Example aspects of the present disclosure are described herein in the context of devices, systems, methods, and computer-readable media for providing mobile ad hoc networking capability to a radio system. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same items.

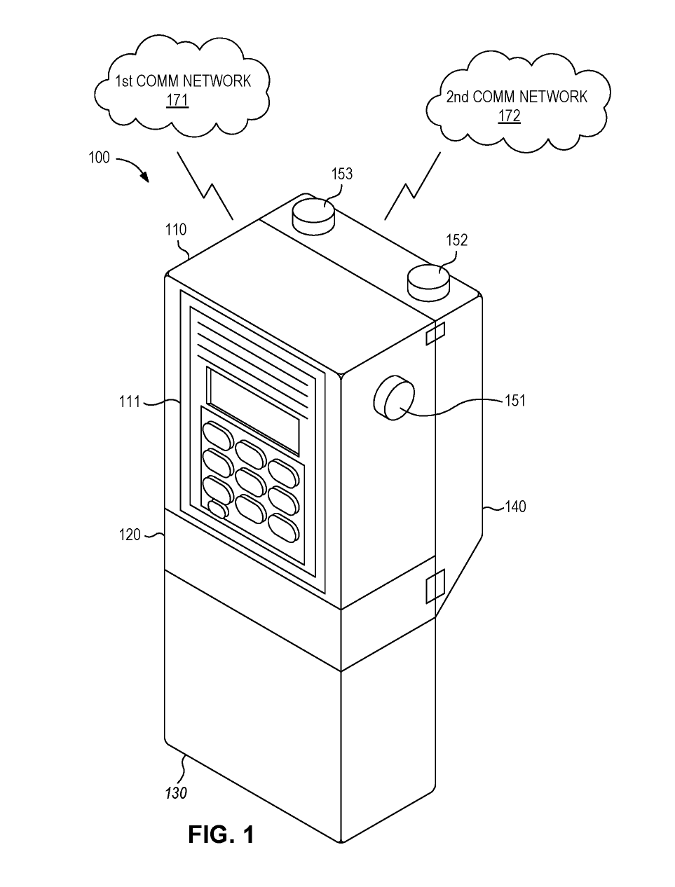

FIG. 1 is a diagram illustrating an example aspect of a mission module system for providing mobile ad hoc networking capability to a radio system according to one aspect of the disclosure. As shown in FIG. 1, the mission module system 100 may be a modular system that may include a radio 110, an interface adapter module 120, a battery 130, and a mission module 140. The interface adapter module 120 may be removably attached to the radio 110; the battery 130 may be removably attached to the interface adapter module 120; and the mission module 140 may be removably attached to the interface adapter module 120, as well as the radio 110.

The radio 110 may be a field proven hand-held radio, such as JEM, made by Thales Communications, Inc., of Clarksburg, Md. The radio 110, as a separate element from the interface adapter module 120, the battery 130, and the mission module 140, may include various components for receiving and transmitting communication signals using a first radio technology, such as, for example, Very High Frequency (VHF), Ultra High Frequency (UHF), L-Band, a legacy military waveform, or a narrowband voice channel. For example, the radio 110 may be configured to communicate via a first communications network 171 using the first radio technology.

The mission module 140 may include various components for receiving and transmitting communication signals using a second radio technology, such as, for example, Code Division Multiple Access (CDMA), Time Division Multiple Access (TDMA), Frequency Division Multiple Access (FDMA), Orthogonal Frequency Division Multiple Access (OFDMA), Single Carrier Frequency Division Multiple Access (SC-FDMA) or any other wideband voice and data system. The terms “system” and “network” are often used interchangeably herein. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved Universal Mobile Telecommunications Service (UMTS) Terrestrial Radio Access (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, Bluetooth® and any other short- or long-range, wireless communication techniques. For example, the mission module 140 may be configured to communicate with a second communications network 172 using the second radio technology.

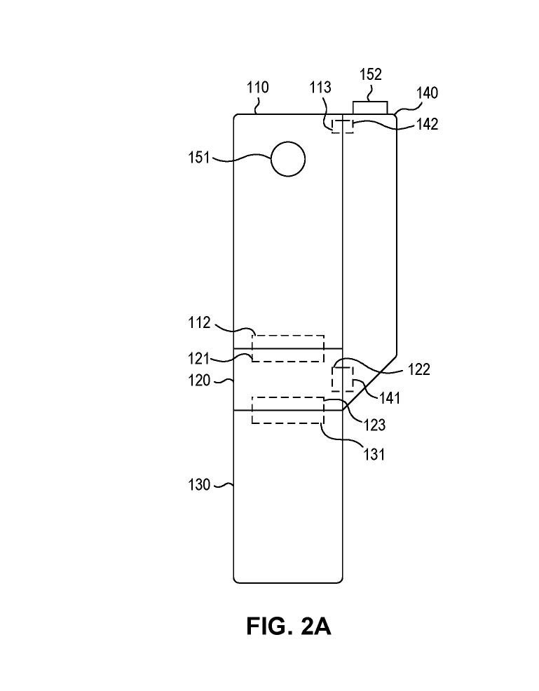

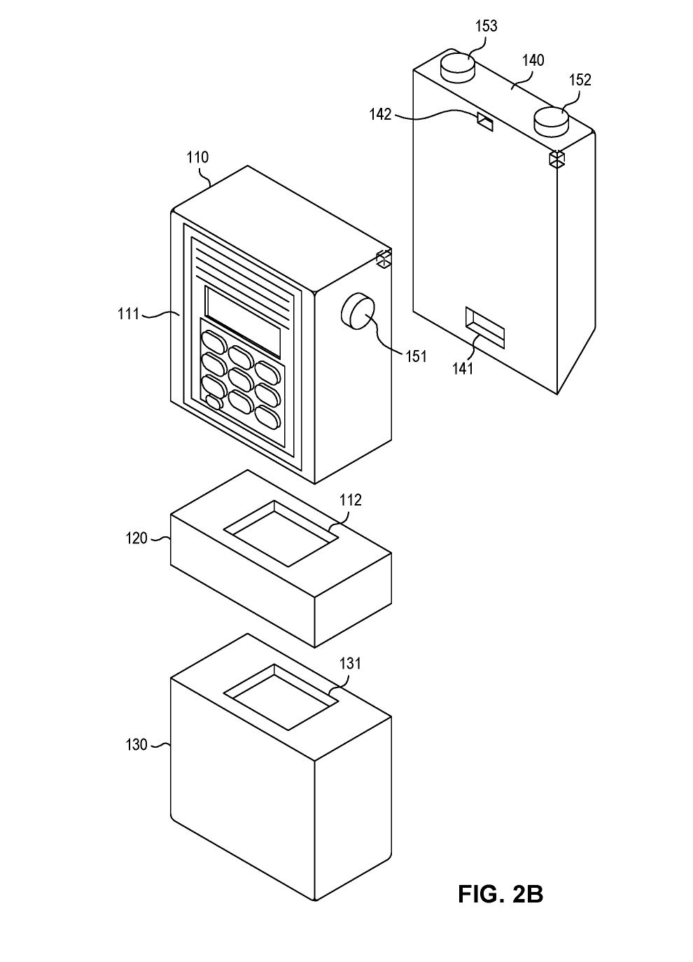

FIGS. 2A and 2B are diagrams illustrating a side view and an exploded view, respectively, of an example aspect of a mission module system for providing mobile ad hoc networking capability to a radio system according to one aspect of the disclosure. As shown in FIGS. 2A and 2B, each of the components 110, 120, 130, 140 of the mission module system 100 may include connectors for physically connecting and/or electrically connecting/coupling the respective components. For example, the radio 110 may include a radio connector 112 that may be configured to connect to a first interface adapter module connector 121 of the interface adapter module 120. The connectors 112 and 121 may be configured to physically secure the radio 110 to the interface adapter module 120. The connectors 112 and 121 may also provide a power connection and a data connection/coupling between the radio 110 and the interface adapter module 120.

The interface adapter module 120 may include a second interface adapter module connector 122 having a plurality of pins (e.g., 22 pins). One of the pins may be a mode pin that, by sensing different resistance values, may detect whether the mission module 140 may be connected to the interface adapter module 120 or may be detached from the interface adapter module 120, and may set the mode (e.g., connected or disconnected) of the mission module 140 accordingly.

The mission module 140 may include a mission module connector 141 that may be configured to connect or couple to the second interface adapter module connector 122 of the interface adapter module 120. The connectors 141 and 122 may be configured to physically secure the mission module 140 to the interface adapter module 120. The connectors 141 and 122 may also provide a power connection and a data connection/coupling between the mission module 140 and the interface adapter module 120, thereby interfacing the mission module 140 with the radio 110. The mission module 140 may also include a connector 142 that may interface with connector 113 disposed on the radio 120. The connectors 142 and 113 may be configured to physically secure the mission module 140 to the radio 120.

The battery 130 may include a battery connector 131 that may be configured to connect to a third interface adapter module connector 123 of the interface adapter module 120. The connectors 131 and 123 may be configured to physically secure the battery 130 to the interface adapter module 120. The connectors 131 and 123 may also provide a power connection between the battery 130 and the interface adapter module 120 via which the battery 130 may supply power to the radio 120 and the mission module 140.

When combined, the radio 110, the interface adapter module 120, the battery 130, and the mission module 140 may constitute the mission module system 100. As a whole, the mission module system 100 may be able to simultaneously or contemporaneously communicate via the first and second networks 171, 172 using the first and second radio technologies, respectively. For example, a mission module system 100 may allow a user to share a video via the mission module 140 while contemporaneously communicating on a legacy military waveform via the radio 110.

According to an aspect, the mission module 140 may be pre-programmed via a device that may connect or couple directly to a connector 153 on the mission module 140. Pre-programming the mission module 140 may configure the mission module 140 with a capability to automatically connect/couple with other mission modules and/or other radios in an ad hoc network, such as the second communications network 172.

During operation, when the assembled mission module system 100 is powered on, a user may activate the mission module 140 through a user interface 111 on the radio 110. Once the mission module 140 is activated, the radio 110 may provide power to the mission module 140 from the battery 130 via the interface adapter module 120 and/or from an internal battery (not shown) of the radio 110. The radio 110 may then perform an authentication procedure to authenticate the mission module 140 and ensure that the mission module 140 is genuine. Once the mission module 140 is authenticated, the radio 110 may continue to provide power to the mission module 140 and to maintain a data interface connection/coupling with the mission module 140 via the interface adapter module 120. After authentication, the mission module 140 may automatically join the second communications network 172 that it may have been pre-programmed to connect/couple to, and communicate using the second radio technology with any other mission modules or radios in the second communications network 172. In this manner, a user of the mission module system 100 may communicate with both the first communications network 171 and the second communications network 172, for example.

According to an aspect, the mission module 140 and the radio 110 may also be connected/coupled via their respective data ports. For example, the mission module 140 may have a first data port 151, and the radio 110 may have a second data port 152. The first and second data ports 151, 152 may be connected via a cable (not shown), for example, which allows the radio 110 and the mission module 140 to share data across each other's respective networks. For example, the mission module 140 may receive data from the second communications network 172, and relay via the data ports 151, 152 the received data to the radio 110, which may transmit the relayed data via the first communications network 171. The mission module 140 may be configured via the user interface 111 to relay all or a subset of the data to the radio 110 for transmission to the first communications network 171. Similarly, the radio 110 may receive data from the first communications network 171, and relay, via the data ports 151, 152, the received data to the mission module 140, which may in turn transmit the relayed data to the second communications network 172. The radio may be configured via the user interface 111 to relay all or a subset of the data to the mission module 140 for transmission to the second communications network 172.

According to an aspect, the radio 110 may issue various commands and queries to the mission module 140 via the interface adapter module 120. For example, such commands and queries may include a volume command, a talkgroup command, a zeroize command, an operation status query, a software version query, a serial number query, and an Internet protocol (IP) address query.

The volume command may instruct the mission module 140 to change to a new volume. In response, the mission module 140 may verify the validity of the volume value, change to the new volume, and acknowledge the command by transmitting an acknowledgement to the radio 110.

The talkgroup command may instruct the mission module 140 to change to a new talkgroup. In response, the mission module 140 may verify the validity of the talkgroup value, change to the new talkgroup, and acknowledge the command by transmitting an acknowledgement to the radio 110.

The zeroize command may instruct the mission module 140 to zeroize one or more parameters. In response, the mission module 140 may zeroize the parameter and acknowledge the command by transmitting an acknowledgement to the radio 110.

The operational status query may instruct the mission module 140 to provide its operational status. In response, the mission module 140 may provide to the radio 110 the operation status of a number of parameters, such as its volume value, the talkgroup value, data rate, etc.

The software version query may instruct the mission module 140 to provide its software version. In response, the mission module 140 may provide to the radio 110 a value of the software version that it is operating (e.g., v.01.02.0003).

The serial number query may instruct the mission module 140 to provide its serial number. In response, the mission module 140 may provide to the radio 110 a value of its serial number.

The IP address query may instruct the mission module 140 to provide its IP address. In response, the mission module 140 may provide to the radio 110 a value of its IP address.

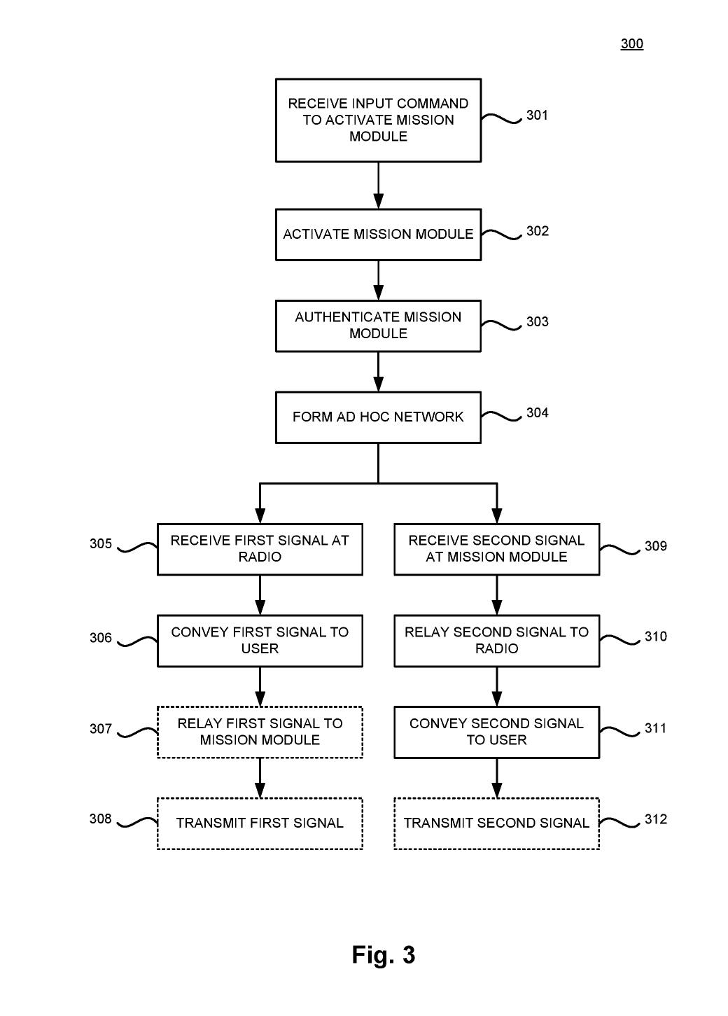

FIG. 3 is a flow diagram illustrating an example method 300 for providing mobile ad hoc networking capability to a radio system according to one aspect of the disclosure. The process described in this flow diagram may be implemented in a mission module system, such as the system 100 shown in FIG. 1. As shown in FIG. 3, the process may begin in block 301, where an input may be received at a radio to activate a mission module, which may be removably attached to the hand held radio. For example, referring to FIG. 1, the radio 110 may receive from a user via the user interface 111 a command to activate the mission module 140.

In block 302, the mission module may be activated. For example, the radio 110 may activate the mission module 140, as shown in FIG. 1. In block 303, the mission module may be authenticated. For example, referring to FIG. 1, the radio 110 may authenticate the mission module 140 to ensure that it is genuine. In block 304, an ad hoc network may be formed. For example, the mission module 140 (FIG. 1), once authenticated, may automatically form an ad hoc network, such as the second communications network, by communicating with other mission modules and/or radios.

The process may then proceed to blocks 305 and 309 either concurrently or sequentially because the mission module system 100 may be capable of communicating with the first communications network via the radio 110, for example, while contemporaneously communicating with the second communications network via the mission module 140.

In block 305, a first signal may be received at the radio from the first communications network. For example, as shown in FIG. 1, the radio 110 may receive a first signal from the first communications network 171. In block 306, the first signal may be conveyed to a user. As another example, referring to FIG. 1, the user may listen to a voice signal or view a data signal using the user interface 111.

In block 307, the first signal may optionally be relayed to the mission module. For example, referring to FIG. 1, based on an input from the user, the radio 110 may relay the first signal to the mission module 140 for transmission to the second communications network 172. In block 308, the mission module (e.g., module 140 in FIG. 1) may transmit the first signal to the second communications network (e.g., network 172 in FIG. 1) using the second radio technology.

In block 309, a second signal may be received at the mission module from the second communications network. For example, referring to FIG. 1, the mission module 140 may receive a second signal from the second communications network 172. In block 310, the second signal may be relayed to the radio. For example, referring to FIG. 1, the mission module 140 may relay the second signal to the radio 110 in order to convey the signal to the user. In block 311, the second signal may be conveyed to the user. For example, referring to FIG. 1, the user may listen to a voice signal or view a data signal using the user interface 111.

In block 312, based on user input, the radio (e.g., radio 110 in FIG. 1) may optionally transmit the second signal to the first communications network (e.g., network 171 in FIG. 1) using the first radio technology.

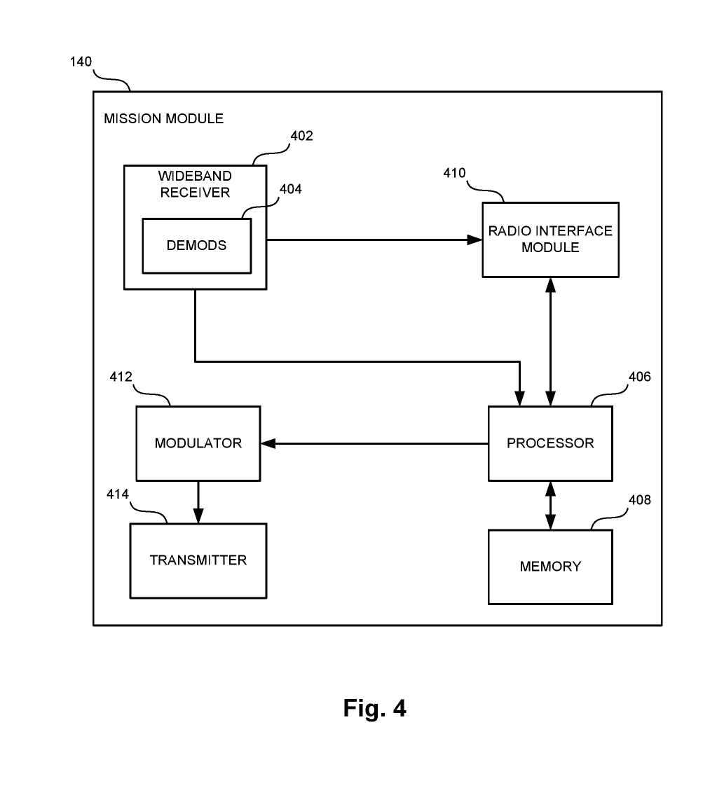

FIG. 4 is a block diagram of the example mission module 140 of FIG. 1, which may provide mobile ad hoc networking capability to a radio (e.g., radio 110 in FIG. 1) in a mission module radio system (e.g., system 100 in FIG. 1). As shown in FIG. 4, the mission module 140 may include a receiver 402 that receives multiple signals from, for instance, one or more receive antennas (not shown), performs typical actions on (e.g., filters, amplifies, downconverts) the received signals, and digitizes the conditioned signals to obtain samples. The receiver 402 may include a plurality of demodulators 404 that may demodulate received symbols from each signal and may provide them to a processor 406 for channel estimation, as described herein. The processor 406 may be a processor dedicated to analyzing information received by the receiver 402 and/or generating information for transmission by a transmitter 414, a processor that controls one or more components of mission module 140, and/or a processor that both analyzes information received by the receiver 402, generates information for transmission by the transmitter 414, and controls one or more components of the mission module 140.

The mission module 140 may additionally include memory 408 that may be operatively coupled to the processor 406 and that may store data to be transmitted, received data, information related to available channels, data associated with analyzed signal and/or interference strength, information related to an assigned channel, power, rate, or the like, and/or any other suitable information for estimating a channel and communicating via the channel. Memory 408 may additionally store protocols and/or algorithms associated with estimating and/or utilizing a channel (e.g., performance based, capacity based).

It will be appreciated that the data store (e.g., memory 408) described herein may be either volatile memory or nonvolatile memory, or may include both volatile and nonvolatile memory. By way of illustration, and not limitation, nonvolatile memory may include read only memory (ROM), programmable ROM (PROM), electrically programmable ROM (EPROM), electrically erasable PROM (EEPROM), or flash memory. Volatile memory may include random access memory (RAM), which acts as external cache memory. By way of illustration and not limitation, RAM may be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 408 of the subject systems and methods is intended to comprise, without being limited to, these and any other suitable types of memory.

The receiver 402 (e.g., a wideband receiver) may further be operatively coupled to a radio interface module 410 that may interface with a radio, such as radio 110 in FIG. 1 (e.g., transmit/receive information to/from the radio 110 via the interface adapter module 120 and the data ports 151, 152) and receive power via the interface adapter module 120 (FIG. 1), as discussed with reference to FIG. 1. Mission module 140 still further may comprise a modulator 412 that modulates and transmits signals via transmitter 414 to, for instance, other mission modules, radios, a base station, a web/internet access point name (APN), and other mobile devices, etc. Although depicted as being separate from the processor 406, it is to be appreciated that the radio interface module 410, demodulators 404 and/or modulator 412 may be part of the processor 406 or multiple processors (not shown). Furthermore, some or all of the functions of the radio interface module 410 may be integrated in an application layer, a data stack, an HTTP stack, at the operating system (OS) level, in an internet browser application, or in an application specific integrated circuit (ASIC).

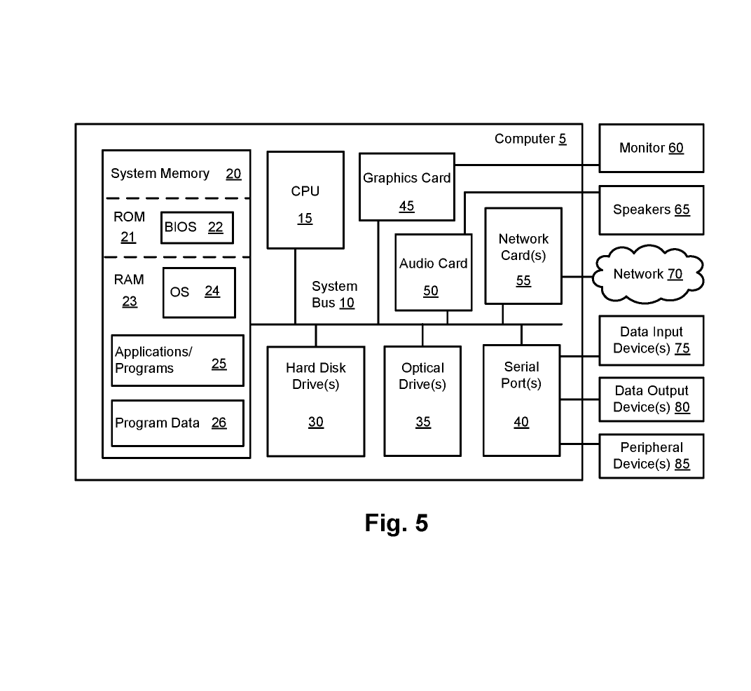

FIG. 5 depicts one example aspect of a computer system 5 that may be used to implement the disclosed systems and methods providing mobile ad hoc networking capability to a radio system according to one aspect of the disclosure. The computer system 5 may be incorporated into one or more components identified in FIGS. 1-4, including, but limited to the mission module system 100 may be a modular system that may include a radio 110, an interface adapter module 120, a battery 130, and a mission module 140 of FIG. 1, and/or such components may be incorporated into such computer system 5, which include, but not be limited to, a personal computer, a notebook, tablet computer, a smart telephone, a mobile device, a network server, a router, or other type of processing device. As shown in FIG. 5, computer system 5 may include one or more central processing units (CPUs) 15 (e.g., hardware processors), memory 20, one or more hard disk drive(s) 30, optical drive(s) 35, serial port(s) 40, graphics card 45, audio card 50 and network card(s) 55 connected by system bus 10. System bus 10 may be any of several types of bus structures including a memory bus or memory controller, a peripheral bus and a local bus using any of a variety of known bus architectures. CPU 15 may include one or more Intel® Core 2 Quad 2.33 GHz processors or other type of microprocessor.

System memory 20 may include a read-only memory (ROM) 21 and random access memory (RAM) 23. System memory 20 may be implemented as in DRAM (dynamic RAM), EPROM, EEPROM, Flash or other type of memory architecture. ROM 21 may store a basic input/output system 22 (BIOS), containing the basic routines that help to transfer information between the modules of computer system 5, such as during start-up. RAM 23 may store operating system 24 (OS), such as Windows® 7 Professional or other type of operating system, that may be responsible for management and coordination of processes and allocation and sharing of hardware resources in computer system 5. System memory 20 also stores applications and programs 25. Memory 20 also stores various runtime data 26 used by programs 25.

Computer system 5 may further include hard disk drive(s) 30, such as SATA HDD, and optical disk drive(s) 35 for reading from or writing to a removable optical disk, such as a CD-ROM, DVD-ROM or other optical media. Drives 30 and 35 and their associated computer-readable media provide non-volatile storage of computer readable instructions, data structures, applications and program modules/subroutines that implement algorithms and methods disclosed herein. Although the example computer system 5 employs magnetic and optical disks, it should be appreciated by those skilled in the art that other types of computer readable media that may store data accessible by a computer system 5, such as magnetic cassettes, flash memory cards, digital video disks, RAMs, ROMs, EPROMs and other types of memory may also be used in alternative aspects of the computer system 5.

Computer system 5 further includes a plurality of serial ports 40, such as Universal Serial Bus (USB), for connecting data input device(s) 75, such as keyboard, mouse, touch pad and other. Serial ports 40 may be also be used to connect data output device(s) 80, such as printer, scanner and other, as well as other peripheral device(s) 85, such as external data storage devices and the like. System 5 may also include graphics card 45, such as nVidia® GeForce® GT 240M or other video card, for interfacing with a monitor 60 (e.g., a display) or other video reproduction device, such as touch-screen display. System 5 may also include an audio card 50 for reproducing sound via internal or external speakers 65. In addition, system 5 may include network card(s) 55, such as Ethernet, WiFi, GSM, Bluetooth® or other wired, wireless, or cellular network interface for connecting computer system 5 to network 70, such as the Internet.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium may comprise RAM, ROM, EEPROM, CD-ROM, Flash memory or other types of electric, magnetic, or optical storage medium, or any other medium that may be used to carry or store desired program code in the form of instructions or data structures and that may be accessed by a processor of a general purpose computer.

In the interest of clarity, not all of the routine features of the aspects are disclosed herein. It will be appreciated that in the development of any actual implementation of the disclosure, numerous implementation-specific decisions may be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

Further, to the extent that the method does not rely on the particular order of steps set forth herein, the particular order of the steps should not be construed as limitation on the claims. The claims directed to the method of the present disclosure should not be limited to the performance of their steps in the order written, and one skilled in the art can readily appreciate that the steps may be varied and still remain within the spirit and scope of the present disclosure.

1. A device, comprising:
a hand-held radio configured to communicate using a first radio technology via a first communications network; and
a mission module configured to communicate using a second radio technology via a second communications network, wherein the mission module is removably attached to the hand-held radio, and wherein the hand-held radio is further configured to communicate via the second communications network via the mission module.

2. The device of claim 1, wherein the mission module is further configured to communicate via the first communications network via the hand-held radio.

3. The device of claim 1, further comprising an interface adapter module, wherein the mission module is removably attached to the hand-held radio via the adapter interface module.

4. The device of claim 3, wherein the adapter interface module is removably attached to the hand-held radio.

5. The device of claim 3, further comprising a battery that is removably attached to the hand-held radio via the adapter interface module.

6. The device of claim 1, wherein the mission module is further configured to automatically form an ad hoc network with other mission modules.

7. The device of claim 1, wherein the hand-held radio is further configured to authenticate the mission module.

8. The device of claim 1, wherein the hand-held radio and the mission module are configured to contemporaneously communicate via the first communications network and the second communications network, respectively.

9. A method, comprising:
receiving a first signal at a hand-held radio via a first communications network using a first radio technology;
receiving a second signal at a mission module that is removably attached to the hand-held radio, wherein the second signal is received at the mission module via a second communications network using a second radio technology;
communicating via the first communications network via the hand-held radio while contemporaneously communicating via the second communications network via the mission module.

10. The method of claim 9, further comprising:
routing at least a part of the second signal to the hand-held radio; and
transmitting at least the part of the second signal from the hand-held radio via the first communications network using the first radio technology.

11. The method of claim 9, further comprising:
routing at least a part of the first signal to the mission module; and
transmitting at least the part of the first signal from the mission module via the second communications network using the second radio technology.

12. The method of claim 9, wherein the mission module is removably attached to the hand-held radio via an adapter interface module.

13. The method of claim 12, wherein the adapter interface module is removably attached to the hand-held radio.

14. The method of claim 9, further comprising:
receiving an input at the hand-held radio to activate the mission module;
activating the mission module;
authenticating the mission module via the hand-held radio; and
automatically forming an ad hoc network with other mission modules via the mission module.

15. A non-transitory computer-readable medium comprising executable code for causing a computer to:
receive a first signal at a hand-held radio via a first communications network using a first radio technology;
receive a second signal at a mission module that is removably attached to the hand-held radio, wherein the second signal is received at the mission module via a second communications network using a second radio technology;
communicate via the first communications network via the hand-held radio while contemporaneously communicating via the second communications network via the mission module.

16. The non-transitory computer-readable medium of claim 15, further comprising executable code for causing the computer to:
route at least a part of the second signal to the hand-held radio; and
transmit at least the part of the second signal from the hand-held radio via the first communications network using the first radio technology.

17. The non-transitory computer-readable medium of claim 15, further comprising executable code for causing the computer to:
route at least a part of the first signal to the mission module; and
transmit at least the part of the first signal from the mission module via the second communications network using the second radio technology.

18. The non-transitory computer-readable medium of claim 15, further comprising executable code for causing the computer to:
receive an input at the hand-held radio to activate the mission module;
activate the mission module;
authenticate the mission module via the hand-held radio; and
automatically form an ad hoc network with other mission modules via the mission module.
